(19) United States
(12) Patent Application Publication
(10) Pub. No.: US 2021/0280156 A1
(43) Pub. Date: Sep. 9, 2021

(54) DYNAMIC REFRESH RATE ADJUSTMENT

(71) Applicant: QUALCOMM Incorporated, San Diego, CA (US)

(72) Inventors: Kalpesh Dhanvantrai Mehta, Hyderabad (IN); Prashant Nukala, Hyderabad (IN)

(21) Appl. No.: 16/807,367

(22) Filed: Mar. 3, 2020

(51) Int. Cl. G09G 5/18; G09G 5/10

(52) U.S. Cl. CPC G09G 5/18; G09G 2320/0261; G09G 2320/0252; G09G 5/10

(57) ABSTRACT

Methods, systems, and devices for dynamic adjustment of a refresh rate of a display are described. The method includes determining a set of frames for display on the device, determining an average frame rate for the set of frames over a duration based on a respective frame rate associated with each frame of the set of frames, selecting a new refresh rate based on the average frame rate for the set of frames, and switching, based on selecting the new refresh rate, from a current refresh rate of the display to the new refresh rate by deactivating a first timing register of the device and activating a second timing register of the device.

### BACKGROUND

The following relates generally to dynamic adjustment of a refresh rate of a display, and more specifically to dynamic refresh rate adjustment improvement.

Graphics devices are used to render 2-dimensional (2-D) and 3-dimensional (3-D) images for various functions, such as video games, graphics programs, computer-aided design (CAD) programs, 3-D printing, simulation and visualization tools, imaging, and the like. A graphics device may perform various graphics operations to render an image. The graphics operations may include rasterization, stencil and depth tests, texture mapping, shading, and the like. A 3-D image may be modeled with surfaces, and each surface may be approximated with polygons, such as triangles. In some cases, a graphics device may utilize a graphics processor to perform certain graphics operations such as shading. In some examples, the graphics processor may be configured to generate video frames at refresh rates above 60 Hertz (Hz). However, setting the refresh rate above 60 Hz may increase the display engine-to-memory bandwidth and may increase the display link line rate relative to a 60 Hz refresh rate.

### SUMMARY

The described techniques relate to improved methods, systems, devices, and apparatuses that support dynamic refresh rate adjustment improvement. Specifically, the described techniques include adjusting the refresh rate dynamically to improve power usage and memory bandwidth usage, without noticeably affecting the user experience. In some examples, the described techniques include a device with a screen configured to determine a set of frames for display on the screen. In some examples, the device receives the set of frames over a duration, determines a frame rate for each of the frames in the set of frames, and then determines an average frame rate for the set of frames over the duration. In some examples, the device selects a new refresh rate based at least in part on the average frame rate for the set of frames and switches, based on selecting the new refresh rate, from a current refresh rate of the screen to the new refresh rate by deactivating a first timing register of the device and activating a second timing register of the device.

A method of dynamic refresh rate adjustment by a device is described. The method may include determining a set of frames for display on the device, determining an average frame rate for the set of frames over a duration based on a respective frame rate associated with each frame of the set of frames, selecting a new refresh rate based on the average frame rate for the set of frames, and switching, based on selecting the new refresh rate, from a current refresh rate of the display to the new refresh rate by deactivating a first timing register of the device and activating a second timing register of the device.

An apparatus for dynamic refresh rate adjustment by a device is described. The apparatus may include a processor, memory coupled with the processor, and instructions stored in the memory. The instructions may be executable by the processor to cause the apparatus to determine a set of frames for display on the device, determine an average frame rate for the set of frames over a duration based on a respective frame rate associated with each frame of the set of frames, select a new refresh rate based on the average frame rate for the set of frames, and switch, based on selecting the new refresh rate, from a current refresh rate of the display to the new refresh rate by deactivating a first timing register of the device and activating a second timing register of the device.

Another apparatus for dynamic refresh rate adjustment by a device is described. The apparatus may include means for determining a set of frames for display on the device, determining an average frame rate for the set of frames over a duration based on a respective frame rate associated with each frame of the set of frames, selecting a new refresh rate based on the average frame rate for the set of frames, and switching, based on selecting the new refresh rate, from a current refresh rate of the display to the new refresh rate by deactivating a first timing register of the device and activating a second timing register of the device.

A non-transitory computer-readable medium storing code for dynamic refresh rate adjustment by a device is described. The code may include instructions executable by a processor to determine a set of frames for display on the device, determine an average frame rate for the set of frames over a duration based on a respective frame rate associated with each frame of the set of frames, select a new refresh rate based on the average frame rate for the set of frames, and switch, based on selecting the new refresh rate, from a current refresh rate of the display to the new refresh rate by deactivating a first timing register of the device and activating a second timing register of the device.

In some examples of the method, apparatuses, and non-transitory computer-readable medium described herein, determining the respective frame rate for each frame of the set of frames may include operations, features, means, or instructions for determining an elapsed time between identifying a first frame from the set of frames and identifying a second frame from the set of frames, the second frame being directly after the first frame in a sequence of the set of frames.

In some examples of the method, apparatuses, and non-transitory computer-readable medium described herein, determining the respective frame rate for each frame of the set of frames further may include operations, features, means, or instructions for determining an instantaneous frame rate for each frame of the set of frames based on the elapsed time.

In some examples of the method, apparatuses, and non-transitory computer-readable medium described herein, determining an average frame rate for the set of frames may include operations, features, means, or instructions for determining the average frame rate based on using the instantaneous frame rate of at least one frame from the set of frames as an input of a lookup table.

In some examples of the method, apparatuses, and non-transitory computer-readable medium described herein, selecting the new refresh rate may include operations, features, means, or instructions for determining a range of frame rates from a set of two or more ranges of frame rates, the range of frame rates including the average frame rate, and determining a mapping between the determined range of frame rates and the new refresh rate based on determining the average frame rate.

In some examples of the method, apparatuses, and non-transitory computer-readable medium described herein, the new refresh rate may be selected from a set of available refresh rates that includes the current refresh rate and the new refresh rate.

In some examples of the method, apparatuses, and non-transitory computer-readable medium described herein, the first timing register may be associated with the current refresh rate, and where the second timing register may be associated with the new refresh rate.

In some examples of the method, apparatuses, and non-transitory computer-readable medium described herein, the second timing register includes one or more preconfigured refresh rate settings for the new refresh rate, and where activating the second timing register includes implementing at least one of the one or more preconfigured refresh rate settings.

In some examples of the method, apparatuses, and non-transitory computer-readable medium described herein, the one or more preconfigured refresh rate settings include one or more horizontal timing settings, or one or more vertical timing settings, or both.

In some examples of the method, apparatuses, and non-transitory computer-readable medium described herein, the second timing register may be activated on a next vertical blank interval.

### BRIEF DESCRIPTION OF THE DRAWINGS

FIG. 1 illustrates an example of a system for dynamic adjustment of a refresh rate of a display that supports dynamic refresh rate adjustment improvement in accordance with aspects of the present disclosure.

FIG. 2 illustrates an example of an environment that supports dynamic refresh rate adjustment improvement in accordance with aspects of the present disclosure.

FIGS. 3 and 4 show block diagrams of devices that support dynamic refresh rate in accordance with aspects of the present disclosure.

FIG. 5 shows a block diagram of a display manager that supports dynamic refresh rate adjustment improvement in accordance with aspects of the present disclosure.

FIG. 6 shows a diagram of a system including a device that supports dynamic refresh rate adjustment improvement in accordance with aspects of the present disclosure.

FIGS. 7 through 9 show flowcharts illustrating methods that support dynamic refresh rate in accordance with aspects of the present disclosure.

### DETAILED DESCRIPTION

Graphics devices are used to render 2-dimensional (2-D) and 3-dimensional (3-D) images for various functions, such as video games, graphics programs, computer-aided design (CAD) programs, 3-D printing, simulation and visualization tools, imaging, and the like. A graphics device may perform various graphics operations to render an image. The graphics operations may include rasterization, stencil and depth tests, texture mapping, shading, and the like. A 3-D image may be modeled with surfaces, and each surface may be approximated with polygons, such as triangles. The number of triangles used to represent a 3-D image for rendering purposes may be dependent on the complexity of the surfaces as well as the desired resolution of the image.

Each triangle may be defined by three vertices, and each vertex is associated with various attributes such as space coordinates, color values, and texture coordinates. When a graphics device uses a vertex processor during the rendering process, the vertex processor may process vertices of the various triangles. Each triangle is also composed of picture elements (pixels). When the graphics device also, or separately, uses a pixel processor during the rendering process, the pixel processor renders each triangle by determining the values of the components of each pixel within the triangle.

In many cases, a graphics device may utilize a graphics processor to perform certain graphics operations such as shading. In some cases, shading may be a relatively complex graphics operation involving lighting and shadowing. In some cases, a graphics processor may execute a variety of instructions when performing rendering, and may use one or more execution units to aid in the execution of the instructions. In some examples, the graphics processor may be configured to generate video frames at refresh rates above 60 Hertz (Hz). However, setting the refresh rate above 60 Hz increases the display engine-to-memory bandwidth and increases the display link line rate relative to a 60 Hz refresh rate.

As with display resolution, refresh rate is increasingly becoming an important consideration for customers purchasing their next graphics device or monitor. There is an increasing push to increase the refresh rates of graphics devices above 60 Hz (e.g., from 60 Hz to 120 Hz or to 240 Hz, etc.). Examples of such graphics devices include television displays, smartphone displays, tablet displays, wearable computer displays, personal computer displays, laptop computer displays, etc.

Frames are individual images of a sequence of images that are shown on a display of a graphics device. For example, a sequence of video images may be played at 24 frames per second (or 24 Hz) to create the appearance of motion. In some examples, videos may be shot at 24, 30, or 60 frames per second (FPS). A refresh rate may reflect how often a display of a graphics device updates frames being shown on the display. In some examples, the refresh rate may limit how many frames per second may be shown on a display. When a video is recorded at a frame rate of 90 frames per second, but the refresh rate of the display showing the video is 60 Hz (e.g., 60 FPS), then some of the 90 frames per second may be dropped since up to 60 frames may be shown per second on a display configured with a 60 Hz refresh rate.

Some graphics devices may configure a refresh rate by software, or a display driver, or both. In some examples, the refresh rate may be set to a fixed rate (e.g., set and forget). A refresh rate of 60 Hz has been a standard refresh rate for some systems. However, currently there is an increasing demand for refresh rates above 60 Hz. However, setting the refresh rate to a fixed rate above 60 Hz (e.g., 120 Hz, 240 Hz, etc.) may introduce negative side effects to platform design. In some examples, setting the refresh rate above 60 Hz may increase the display engine-to-memory bandwidth compared to a 60 Hz fixed rate system (e.g., two times increase for 120 Hz compared to 60 Hz, four times increase for 240 Hz compared to 60 Hz, etc.). Also, setting the refresh rate above 60 Hz also may increase the display link line rate compared to a 60 Hz fixed rate system (e.g., two times increase for 120 Hz compared to 60 Hz, four times increase for 240 Hz compared to 60 Hz, etc.).

The described techniques allow for adaptively and dynamically adjusting the refresh rate without impacting user experience, resulting in lower power usage and longer battery life compared to other fixed rate systems. The described techniques may use any combination of hardware or software methods, or both, to determine a target refresh rate and implement the determined target refresh rate, enabling a graphics device to dynamically adjust its refresh rate based on current conditions. In some examples, the current conditions may include the current operating conditions of the graphics device (e.g., average frame rate, central processor load, graphics processor load, main memory usage, graphics memory usage, system temperature, ambient temperature, ambient light level). In some examples, the current conditions may include constraints of an image being displayed on a screen of the graphics device (e.g., frame rate constraints, refresh rate constraints, etc.).

In some examples, the described techniques enable a graphics device to dynamically modify its refresh rate when there is a determined benefit (e.g., increase the refresh rate from 120 Hz to 240 Hz, decrease the refresh rate from 120 Hz to 60 Hz, etc.). In some examples, the graphics device may determine that increasing the refresh rate results in noticeably sharper images or an improved visual display for the end user (e.g., increasing the frame rate when playing video games or watching content recorded with a relatively high frame rate, etc.). In some examples, the described techniques may enable a graphics device to dynamically decrease its refresh rate when there is no determined benefit to running at higher refresh rates (e.g., reading email, browsing the Internet, social media, etc.), providing a savings in memory bandwidth usage and reducing battery drain. Thus, the described techniques reduce memory bandwidth constraints, reduce display engine throughput constraints, and improve display link speed, resulting in improved system performance and reduced power usage without affecting user experience.

Aspects of the disclosure are initially described in the context of graphical processing systems and environments of graphical processing systems. Aspects of the disclosure are further illustrated by and described with reference to apparatus diagrams, system diagrams, and flowcharts that relate to dynamic refresh rate.

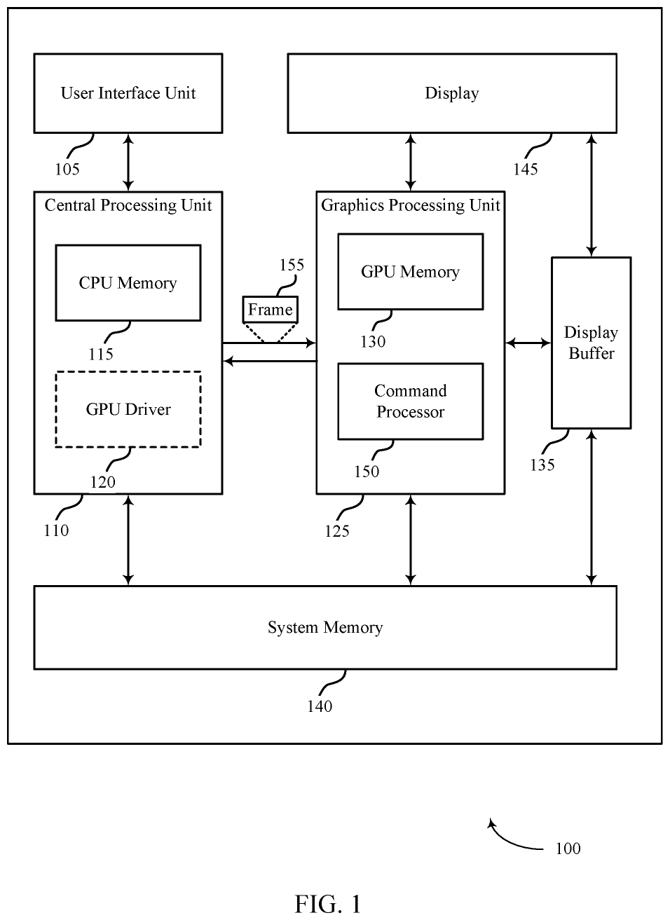

FIG. 1 illustrates an example of a device 100 that supports dynamic refresh rate adjustment improvement in accordance with aspects of the present disclosure. Device 100 may be an example of a graphics device configured for dynamic refresh rate adjustment improvement. Examples of device 100 may include, but are not limited to, wireless devices, mobile or cellular telephones, including smartphones, personal digital assistants (PDAs), video gaming consoles that include o connect to video displays, mobile video gaming devices, mobile video conferencing units, laptop computers, desktop computers, televisions set-top boxes, tablet computing devices, e-book readers, fixed or mobile media players, and the like.

In the example of FIG. 1, device 100 includes a central processing unit (CPU) 110 having CPU memory 115, a graphic processing unit (GPU) 125 having GPU memory 130 and command processor 150, a display 145, a display buffer 135 storing data associated with graphics shown on display 145, a user interface unit 105, and a system memory 140. In some examples, system memory 140 may store a GPU driver 120 (illustrated as being contained within CPU 110 as described herein) having a compiler, a GPU program, a locally-compiled GPU program, and the like. User interface unit 105, CPU 110, GPU 125, system memory 140, and display 145 may communicate with each other (e.g., using a system bus). In some cases, GPU 125 may include or be referred to as a display processing unit (DPU).

Examples of CPU 110 include, but are not limited to, a digital signal processor (DSP), general purpose microprocessor, application specific integrated circuit (ASIC), field programmable logic array (FPGA), or other equivalent integrated or discrete logic circuitry. Although CPU 110 and GPU 125 are illustrated as separate units in the example of FIG. 1, in some examples, CPU 110 and GPU 125 may be integrated into a single chip (e.g. a single chip with one or more processor cores of CPU 110 and one or more processor cores of GPU 125). CPU 110 may include one or more processors to execute one or more software applications. Examples of the applications may include operating systems, word processors, web browsers, e-mail applications, spreadsheets, video games, audio and/or video capture, playback or editing applications, or other such applications that initiate the generation of image data to be presented via display 145. As illustrated, CPU 110 may include CPU memory 115. For example, CPU memory 115 may represent on-chip storage or memory used in executing machine or object code. CPU memory 115 may include one or more volatile or non-volatile memories or storage devices, such as flash memory, a magnetic data media, an optical storage media, etc. CPU 110 may be configured to read values from or write values to CPU memory 115 more quickly than reading values from or writing values to system memory 140, which may be accessed, e.g., over a system bus.

GPU 125 may represent one or more dedicated processors for performing graphical operations. That is, for example, GPU 125 may be a dedicated hardware unit having fixed function and programmable components for processing graphics and executing GPU applications. GPU 125 may also include a DSP, a general purpose microprocessor, an ASIC, an FPGA, or other equivalent integrated or discrete logic circuitry. GPU 125 may be built with a highly-parallel structure that provides more efficient processing of complex graphic-related operations than CPU 110. For example, GPU 125 may include a plurality of processing elements that are configured to operate on multiple vertices or pixels in a parallel manner. The highly parallel nature of GPU 125 may allow GPU 125 to generate graphic images (e.g., graphical user interfaces and two-dimensional or three-dimensional graphics scenes) for display 145 more quickly than CPU 110.

GPU 125 may, in some instances, be integrated into a motherboard of device 100. In other instances, GPU 125 may be present on a graphics card that is installed in a port of or connected to the motherboard of device 100, or may be otherwise incorporated within a peripheral device configured to interoperate with device 100. As illustrated, GPU 125 may include GPU memory 130 and command processor 150. In some examples, GPU memory 130 may represent on-chip storage or memory used in executing machine or object code. GPU memory 130 may include one or more volatile or non-volatile memories or storage devices, such as flash memory, a magnetic data media, an optical storage media, etc. GPU 125 may be able to read values from or write values to GPU memory 130 more quickly than reading values from or writing values to system memory 140, which may be accessed, e.g., over a system bus. That is, GPU 125 may read data from and write data to GPU memory 130 without using the system bus to access off-chip memory. This operation may allow GPU 125 to operate in a more efficient manner by reducing the need for GPU 125 to read and write data via the system bus, which may experience relatively heavy bus traffic.

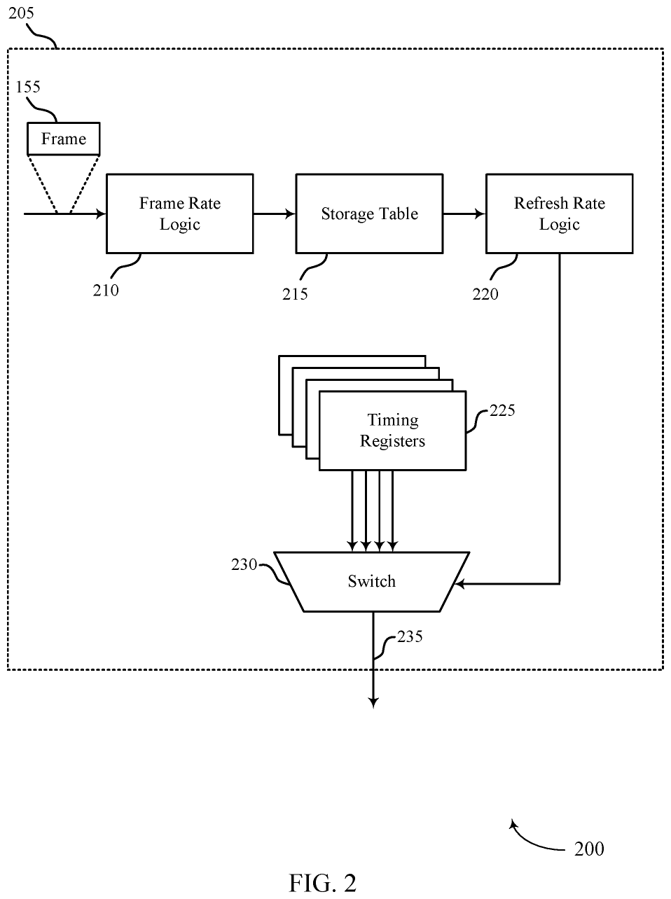

In some examples, command processor 150 may be a first interface between the GPU 125 and a component external to GPU 125. In some cases, command processor 150 may be configured to perform command and stream fetching, state control, and/or register management (e.g., timing registers 225 of FIG. 2). In some examples, command processor 150 may include separate queues for commands, streams, and/or kernels. In some cases, command processor 150 may include direct memory access (DMA) for streams and interrupt control unit. In some examples, command processor 150 may be configured to send interrupts to a host of GPU 125 (e.g., device 100).

Display 145 represents a unit capable of displaying video, images, text or any other type of data for consumption by a viewer. Display 145 may include a liquid-crystal display (LCD), a light emitting diode (LED) display, an organic LED (OLED), an active-matrix OLED (AMOLED), or the like. Display buffer 135 represents a memory or storage device dedicated to storing data for presentation of graphical imagery, such as computer-generated graphics, still images, video frames, or the like for display 145. Display buffer 135 may represent a graphics buffer that includes a plurality of storage locations. The number of storage locations within display buffer 135 may, in some cases, generally correspond to the number of pixels to be displayed on display 145. For example, if display 145 is configured to include 640×480 pixels, display buffer 135 may include 640×480 storage locations storing pixel color and intensity information, such as red, green, and blue pixel values, or other color values. Display buffer 135 may store the final pixel values for each of the pixels processed by GPU 125. Display 145 may retrieve the final pixel values from display buffer 135 and display the final image based on the pixel values stored in display buffer 135.

User interface unit 105 represents a unit with which a user may interact with or otherwise interface to communicate with other units of device 100, such as CPU 110. Examples of user interface unit 105 include, but are not limited to, a trackball, a mouse, a keyboard, and other types of input devices. User interface unit 105 may also be, or include, a touch screen and the touch screen may be incorporated as part of display 145.

System memory 140 may include one or more computer-readable storage media. Examples of system memory 140 include, but are not limited to, a random access memory (RAM), static RAM (SRAM), dynamic RAM (DRAM), a read-only memory (ROM), an electrically erasable programmable read-only memory (EEPROM), a compact disc read-only memory (CD-ROM) or other optical disc storage, magnetic disc storage, or other magnetic storage devices, flash memory, or any other medium that can be used to store desired program code in the form of instructions or data structures and that can be accessed by a computer or a processor. System memory 140 may store program modules and/or instructions that are accessible for execution by CPU 110 (e.g., program modules and/or instructions configured for dynamic refresh rate adjustment improvement). Additionally, system memory 140 may store user applications and application surface data associated with the applications. System memory 140 may in some cases store information for use by and/or information generated by other components of device 100. For example, system memory 140 may act as a device memory for GPU 125 and may store data to be operated on by GPU 125 (e.g., in a direct rendering operation) as well as data resulting from operations performed by GPU 125.

In some examples, system memory 140 may include instructions that cause CPU 110 or GPU 125 to perform the functions ascribed to CPU 110 or GPU 125 in aspects of the present disclosure. System memory 140 may, in some examples, be considered as a non-transitory storage medium. The term “non-transitory” should not be interpreted to mean that system memory 140 is non-movable. In some examples, system memory 140 may be removed from device 100 and moved to another device. As another example, a system memory substantially similar to system memory 140 may be inserted into device 100. In certain examples, a non-transitory storage medium may store data that can, over time, change (e.g., in RAM).

System memory 140 may store a GPU driver 120. In some examples, system memory 140 may store a compiler, or a GPU program, or a locally-compiled GPU program, or any combination thereof. The GPU driver 120 may represent a computer program or executable code that provides an interface to access GPU 125. CPU 110 may execute the GPU driver 120 or portions thereof to interface with GPU 125. GPU driver 120 may be accessible to programs or other executables executed by CPU 110, including the GPU program stored in system memory 140. Thus, when one of the software applications executing on CPU 110 requests graphics processing, CPU 110 may provide graphics commands and graphics data to GPU 125 for showing graphics on display 145 (e.g., via GPU driver 120).

The GPU program may include code written in a high level (HL) programming language, e.g., using an application programming interface (API). Examples of APIs include Open Graphics Library (“OpenGL”), DirectX, Render-Man, WebGL, or any other public or proprietary standard graphics API. The instructions may also conform to so-called heterogeneous computing libraries, such as Open-Computing Language (“OpenCL”), DirectCompute, etc.

The GPU program stored in system memory 140 may invoke or otherwise include one or more functions provided by GPU driver 120. CPU 110 generally executes the program in which the GPU program is embedded and, upon encountering the GPU program, passes the GPU program to GPU driver 120. CPU 110 may execute GPU driver 120 in this context to process the GPU program. That is, for example, GPU driver 120 may process the GPU program by compiling the GPU program into object or machine code executable by GPU 125. This object code may be referred to as a locally-compiled GPU program. In some examples, a compiler associated with GPU driver 120 may operate in real-time or near-real-time to compile the GPU program during the execution of the program in which the GPU program is embedded. In some examples, the compiler may represent a unit that reduces HL instructions defined in accordance with a HL programming language to low-level (LL) instructions of a LL programming language.

In some examples, CPU 110 may generate one or more frames for display on display 145. In the illustrated example, CPU 110 may generate at least frame 155. In some examples, CPU 110 may send frame 155 to GPU 125. In some cases, GPU 125 may perform graphical processing on frame 155. In some examples, frame 155 may be displayed on display 145 based on a current display resolution and current refresh rate for display 145. In some examples, a combination of increasing display resolution and refresh rate may put significant stress on memory bandwidth of device 100. In some examples, the additional memory bandwidth used by device 100 for refresh rates above 60 Hz may not result in any visual benefit to an end user as determined by device 100. By adjusting the refresh rate dynamically, device 100 may increase the refresh rate when device 100 determines that increasing the refresh rate would result in a visual benefit to an end user (e.g., device 100 determines increasing the refresh rate results in sharper images or smoother video graphics for the end user). Similarly, device 100 may decrease the refresh rate when device 100 determines that decreasing the refresh rate does not result in a visual detriment to an end user (e.g., device 100 determines there is no apparent visual benefit to running at a current refresh rate, device 100 determines a current refresh rate exceeds a refresh rate constraint, device 100 determines a lower refresh rate does not diminish a user experience based on a type of image being displayed on display 145 or a determination of a frame rate associated with content from the image being displayed on display 145, etc.).

Accordingly, device 100 may be configured to dynamically adjust the refresh rate to increase power savings and reduce memory bandwidth usage without affecting the user experience (e.g., dynamically adjusting the refresh rate while avoiding flickering, screen tearing, screen stuttering, dropping frames, blank screen, blurring, etc.).

FIG. 2 illustrates an example of a GPU environment 200 that supports dynamic refresh rate adjustment improvement in accordance with aspects of the present disclosure. In some examples, GPU environment 200 may implement aspects of device 100. In some cases, GPU environment 200 may include device 205. In some cases, device 205 may be an example of device 100 of FIG. 1, or CPU 110, or GPU 125, or any combination thereof. As shown, device 205 may include frame 155 of FIG. 1, frame rate logic 210, storage table 215, refresh rate logic 220, timing registers 225, switch 230, and output 235.

In some examples, device 205 may be configured for dynamic refresh rate adjustment improvement. In some examples, device 205 may be configured to determine an target refresh rate for a display of device 205. In some examples, the target refresh rate may include a refresh rate that is equal to or greater than a frame rate associated with a display of device 205. In some examples, the target refresh rate may include a refresh rate that maintains a determined level of quality of an end user's visual experience (e.g., maintains a determined level of sharpness, remains below a determined level of blurring, no dropped frames or remains below a determined number of dropped frames, etc.). Accordingly, device 205 may be configured to adjust the refresh rate dynamically to improve power usage and memory bandwidth usage, without noticeably affecting the user experience.

In some examples, frame rate logic 210 may include a counter (e.g., digital logic counter) that stores the number of times an event or process occurs. In some examples, frame rate logic 210 may measure the instantaneous frame rate at any given point of time. In some examples, frame rate logic 210 may determine how many frames (including frame 155) frame rate logic 210 receives in a determined period of time (e.g., how many frames received in 1 second, etc.). In some examples, frame rate logic 210 may determine how much time lapses between each received frame. In some examples, frame rate logic 210 may determine that a frame is received every 16.67 milliseconds (ms). In some examples, frame rate logic 210 may output one or more values to storage table 215, which may be a lookup table. For example, frame rate logic 210 may output a determined time period between received frames (e.g., output 16.67 ms to storage table 215).

In some examples, storage table 215 may receive an output from frame rate logic 210 and perform analysis based on the received output. In some examples, storage table 215 may calculate a frame rate based on an output received from frame rate logic 210. In some examples, storage table 215 may include query logic to determine a frame rate based on output received from frame rate logic 210. In some examples, storage table 215 may use lookup logic to determine or approximate a frame rate. In some examples, frame rate logic 210 may determine the frames are being provided for display every 30 ms. Storage table 215 may then return 35 Hz based on a lookup table indicating a time period of 30 ms corresponds to 35 Hz. In some examples, storage table 215 may output one or more values (e.g., one or more determined frame rates) to refresh rate logic 220.

In some examples, refresh rate logic 220 may determine a refresh rate based on one or more values refresh rate logic 220 receives from storage table 215. In some examples, refresh rate logic 220 may determine a refresh rate based on an average of two or more values refresh rate logic 220 receives from storage table 215. In some examples, refresh rate logic 220 may determine a refresh rate based on a weighted average of two or more values refresh rate logic 220 receives from storage table 215. In some examples, refresh rate logic 220 may determine a refresh rate based on rounding the average or weighted average of the two or more values to a nearest supported refresh rate. In some examples, refresh rate logic 220 may determine a refresh rate based on rounding the average (e.g., weighted average) of the two or more values to a nearest supported refresh rate that is greater than the rounded average of the two or more values (e.g., rounded average frame rate). In some examples, refresh rate logic 220 may receive a frame rate of 80.8 Hz as a first value from storage table 215, a frame rate of 79.2 Hz as a second value from storage table 215, and a frame rate of 81.2 Hz as a third value from storage table 215. In the example, refresh rate logic 220 may give an equal weight to each value and determine the average of the three equally weighted values is (80.8+79.2+81.2)/3=80.4 Hz. In the example, refresh rate logic 220 may determine that supported refresh rates include 60 Hz, 90 Hz, 120 Hz, and 150 Hz. Accordingly, refresh rate logic 220 may determine that the nearest supported refresh rate that is greater than 80.4 Hz is 90 Hz. Based on the determination, refresh rate logic 220 may select 90 Hz as the refresh rate.

In the example, refresh rate logic 220 may use 60 Hz for any rounded average frame rate that is less than 60 Hz, use 90 Hz for any rounded average frame rate that is less than 90 Hz and greater than or equal to 60 Hz, use 120 Hz for any rounded average frame rate that is less than 120 Hz and greater than or equal to 90 Hz, and use 150 Hz for any rounded average frame rate that is less than 150 Hz and greater than or equal to 90 Hz, etc. If 150 Hz is the highest supported refresh rate, then refresh rate logic 220 may use 150 Hz for any rounded average frame rate that is greater than or equal to 90 Hz.

In some examples, refresh rate logic 220 may implement a selected refresh rate via switch 230. In some examples, the selected refresh rate may take effect on a next vertical blank interval. In some examples, the frequency of the selected refresh rate may be higher or lower than a current refresh rate. In some examples, the current refresh rate may be maintained based on the operations of frame rate logic 210, or storage table 215, or refresh rate logic 220, or the operation of any combination thereof.

As shown, switch 230 may be configured to switch between one or more timing registers 225. In some examples, timing registers 225 may include banks of registers with preset refresh rate settings. Examples of the pre-determined refresh rate settings include at least one of a refresh rate, or GPU refresh rate, or GPU pixel clock, or horizontal resolution, horizontal active pixels, or horizontal front porch, or horizontal back porch, or horizontal blanking total, or horizontal total pixels, or horizontal timing polarity, or horizontal sync, or horizontal sync width, or horizontal sync polarity, or horizontal frequency, or pixel time, or pixel clock frequency, or vertical resolution, or vertical active lines, or vertical total lines, or vertical front porch, or vertical back porch, or vertical sync width, or vertical blanking total, or vertical sync polarity, or vertical frequency, or line time, or frame time, or vertical timing polarity, or interlaced scan, or progressive scan, or any combination thereof. In some examples, refresh rate (e.g., configurable system refresh rate) may refer to the number of times a screen is refreshed or redrawn per second. In some examples, GPU refresh rate may refer to a maximum number of pixels per second a GPU is configured to write to memory.

In some configurations, the refresh rate (e.g., configurable system refresh rate) may not exceed the GPU refresh rate. In some examples, GPU pixel clock may refer to a speed at which pixels are transmitted within one refresh cycle. In some examples, horizontal resolution may refer to the number of horizontal pixels (e.g., from left to right) on the display screen, and vertical resolution may refer to the number of vertical pixels (e.g., from top to bottom) on the display screen. In some examples, interlaced scanning may refer to one-half of the horizontal pixel rows being refreshed in a first cycle and the other half of the horizontal pixel rows being refreshed in a second cycle following (e.g., directly following) the first cycle.

In some examples, progressive scanning may refer to the every horizontal pixel row being refreshed in a single cycle. In some examples, horizontal front porch may refer to the number of pixels between the end of an active area and a next horizontal sync (e.g., distance between the bottom of the display to the lower most portion of the actual image). In some examples, vertical front porch may refer to the number of lines between the end of the active area and the next vertical sync (e.g., distance between the right portion of the display to the right-most portion of the actual image).

In some examples, horizontal timing polarity may set horizontal sync signals to active high (e.g., positive pulse marks the start or end of a horizontal row of pixels) or active low (negative pulse marks the start or end of a horizontal row of pixels). In some examples, vertical timing polarity may set the vertical sync signals to active high (e.g., positive pulse marks the top or bottom of a vertical line of pixels) or active low (e.g., negative pulse marks the top or bottom of a vertical line of pixels).

In some examples, each bank of registers from timing registers 225 may include one or more registers configured to implement preset refresh rate settings. For example, a first bank of timing registers from the timing registers 225 may be configured to implement a first set of refresh rate settings for a first refresh rate, while a second bank of timing registers from the banks of timing registers may be configured to implement a second set of refresh rate settings for a second refresh rate, where at least one setting from the second set of refresh rate settings is different from at least one corresponding setting of the first set of refresh rate settings.

In some examples, a system may be configured to implement 4 refresh rates (e.g., a first refresh rate of 60 Hz, a second refresh rate of 80 Hz, a third refresh rate of 100 Hz, and a fourth refresh rate of 120 Hz). Accordingly, this exemplary system may be configured with one or more first registers from timing registers 225 to implement the first refresh rate of 60 Hz, one or more second registers from timing registers 225 to implement the second refresh rate of 80 Hz, and so on. As shown, switch 230 may provide output 235 based on the selected refresh rate. In some examples, output 235 may include information or refresh rate configuration that is outputted to a display buffer (e.g., display buffer 135 of FIG. 1) or to a display (e.g., display 145 of FIG. 1).

Table 1 provides an exemplary demonstration of power savings provided by the dynamic refresh rate adjustment improvement performed by device 205. As shown, frame rate logic 210 may determine the current frame rate is 24 Hz and refresh rate logic 220 may determine the current refresh rate is 120 Hz. Accordingly, refresh rate logic 220 may select and implement a new refresh rate of 60 Hz, which provides a power savings of 50% to device 205.

TABLE 1

| Frame Rate | Current Refresh Rate | New Refresh Rate | Power Savings |
|---|---|---|---|
| 24 Hz | 120 Hz | 60 Hz | 50% |
| 70 Hz | 120 Hz | 80 Hz | 33% |
| 90 Hz | 120 Hz | 100 Hz | 20% |

Table 2 provides an exemplary demonstration memory bandwidth savings provided for a 4K display based on the dynamic refresh rate adjustment improvement performed by device 205.

TABLE 2

| | | | Memory |
|---|---|---|---|
| Current Frame | Current Refresh | New Refresh | Bandwidth |
| Rate | Rate | Rate | Savings |
| 24 Hz | 120 Hz = 3.8 GB/s | 60 Hz = 1.9 GB/s | 1.9 GB/s |
| 70 Hz | 120 Hz = 3.8 GB/s | 80 Hz = 2.5 GB/s | 1.2 GB/s |
| 90 Hz | 120 Hz = 3.8 GB/s | 100 Hz = 3.2 GB/s | 0.6 GB/s |

As shown, frame rate logic 210 may determine the current frame rate is 70 Hz and refresh rate logic 220 may determine the current refresh rate is 120 Hz. Accordingly, refresh rate logic 220 may select and implement a new refresh rate of 80 Hz. As shown, a refresh rate of 120 Hz may correspond to a memory bandwidth of 3.8 gigabytes per second (GB/s), while a refresh rate of 80 Hz may correspond to a memory bandwidth of 2.5 GB/s. Accordingly, switching to the new refresh rate of 80 Hz from 120 Hz provides a memory bandwidth savings of 1.2 GB/s.

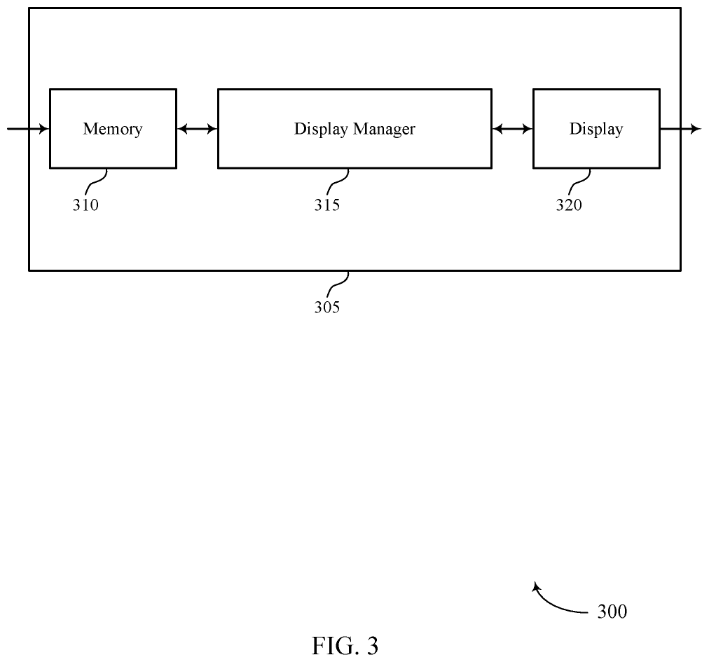

FIG. 3 shows a block diagram 300 of a device 305 that supports dynamic refresh rate adjustment improvement in accordance with aspects of the present disclosure. The device 305 may be an example of aspects of a device as described herein. The device 305 may include a memory 310, a display manager 315, and a display 320. The device 305 may also include a processor. Each of these components may be in communication with one another (e.g., via one or more buses).

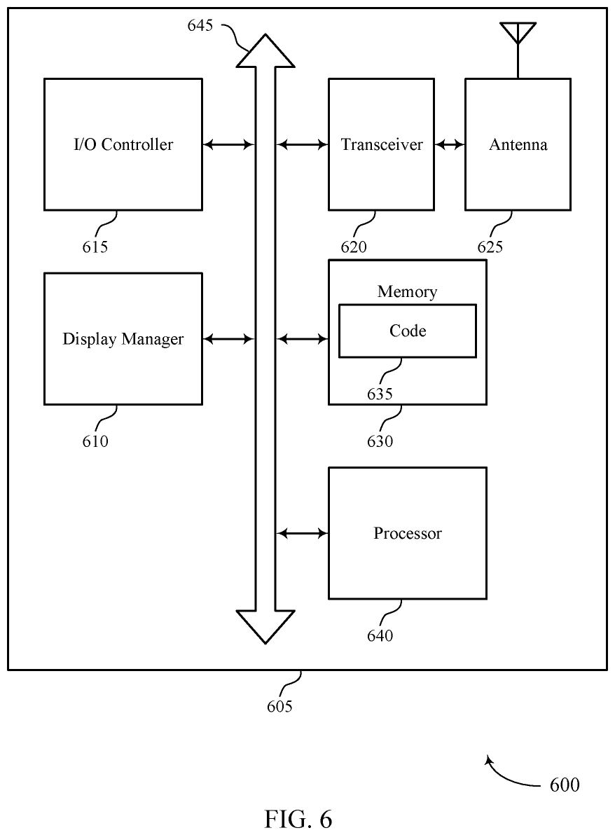

The memory 310 may store information (e.g., monitoring data, change detection data, analysis data, image metadata) generated by other components of device 305 such as display manager 315. For example, memory 310 may store one or more images samples that display manager 315 compares with an output of display manager 315. In some examples, the memory 310 may be collocated with one or more graphics processors in a graphics display device (e.g., device 305). For example, the memory 310 may be an example of aspects of the memory 630 described with reference to FIG. 6. Memory 310 may include one or more computer-readable storage media. Examples of memory 310 include, but are not limited to, random access memory (RAM), static RAM (SRAM), dynamic RAM (DRAM), read-only memory (ROM), electrically erasable programmable read-only memory (EEPROM), compact disc read-only memory (CD-ROM) or other optical disc storage, magnetic disc storage, or other magnetic storage devices, flash memory, or any other medium that can be used to store desired program code in the form of instructions or data structures and that can be accessed by a computer or a processor (e.g., display manager 315).

The display manager 315 may determine a set of frames for display on the device, determine an average frame rate for the set of frames over a duration based on a respective frame rate associated with each frame of the set of frames, select a new refresh rate based on the average frame rate for the set of frames, and switch, based on selecting the new refresh rate, from a current refresh rate of the display to the new refresh rate by deactivating a first timing register of the device and activating a second timing register of the device. The display manager 315 may be an example of aspects of the display manager 610 described herein.

The display manager 315, or its sub-components, may be implemented in hardware, code (e.g., software or firmware) executed by a processor, or any combination thereof. If implemented in code executed by a processor, the functions of the display manager 315, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The display manager 315, or its sub-components, may be physically located at various positions, including being distributed such that portions of functions are implemented at different physical locations by one or more physical components. In some examples, the display manager 315, or its sub-components, may be a separate and distinct component in accordance with various aspects of the present disclosure. In some examples, the display manager 315, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The display 320 may display graphics based on processing performed by display manager 315 (e.g., processing of alias instructions by display manager 315). In some examples, display 320 may or at least some of its sub-components may be implemented in hardware, software executed by a processor, firmware, or any combination thereof. When implemented in software executed by a processor, the functions of the display 320 and/or at least some of its various sub-components may be executed by display manager 315, which may include at least one of a general-purpose processor, a DSP, an ASIC, an FPGA or other programmable logic device, discrete gate or transistor logic, discrete hardware components, or any combination thereof designed to perform the functions described in the present disclosure.

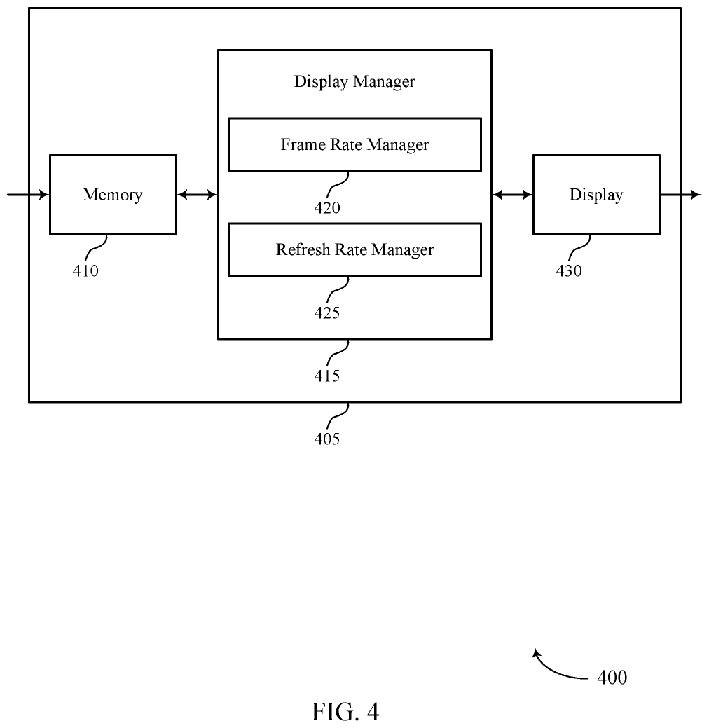

FIG. 4 shows a block diagram 400 of a device 405 that supports dynamic refresh rate adjustment improvement in accordance with aspects of the present disclosure. The device 405 may be an example of aspects of a device 305 or a device 100 as described herein. The device 405 may include a memory 410, a display manager 415, and a display 430. The device 405 may also include a processor. Each of these components may be in communication with one another (e.g., via one or more buses).

The memory 410 may receive, transmit, or store information, data, or signals generated by other components of the device 405. In some examples, the memory 410 may be collocated with one or more graphics processors in an imaging device (e.g., device 405). In some examples, the memory 410 may be an example of aspects of memory 630 described with reference to FIG. 6.

The display manager 415 may be an example of aspects of the display manager 315 as described herein. The display manager 415 may include a frame rate manager 420 and a refresh rate manager 425. The display manager 415 may be an example of aspects of the display manager 610 described herein.

The frame rate manager 420 may determine a set of frames for display on the device and determine an average frame rate for the set of frames over a duration based on a respective frame rate associated with each frame of the set of frames.

The refresh rate manager 425 may select a new refresh rate based on the average frame rate for the set of frames and switch, based on selecting the new refresh rate, from a current refresh rate of the display to the new refresh rate by deactivating a first timing register of the device and activating a second timing register of the device.

The display 430 may display graphics based on processing performed by display manager 415 (e.g., processing of alias instructions by display manager 415). In some examples, display 430 may or at least some of its sub-components may be implemented in hardware, software executed by a processor, firmware, or any combination thereof. When implemented in software executed by a processor, the functions of the display 430 and/or at least some of its various sub-components may be executed by display manager 315, which may include at least one of a general-purpose processor, a DSP, an ASIC, an FPGA or other programmable logic device, discrete gate or transistor logic, discrete hardware components, or any combination thereof designed to perform the functions described in the present disclosure.

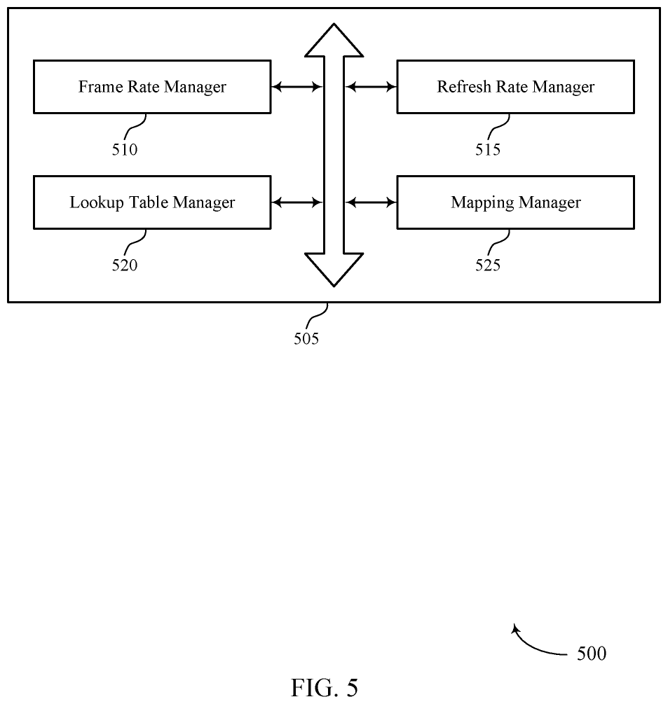

FIG. 5 shows a block diagram 500 of a display manager 505 that supports dynamic refresh rate adjustment improvement in accordance with aspects of the present disclosure. The display manager 505 may be an example of aspects of a display manager 315, a display manager 415, or a display manager 610 described herein. The display manager 505 may include a frame rate manager 510, a refresh rate manager 515, a lookup table manager 520, and a mapping manager 525. Each of these modules may communicate, directly or indirectly, with one another (e.g., via one or more buses).

The frame rate manager 510 may determine a set of frames for display on the device. In some examples, the frame rate manager 510 may determine an average frame rate for the set of frames over a duration based on a respective frame rate associated with each frame of the set of frames.

In some examples, the frame rate manager 510 may determine an elapsed time between identifying a first frame from the set of frames and identifying a second frame from the set of frames, the second frame being directly after the first frame in a sequence of the set of frames.

In some examples, the frame rate manager 510 may determine an instantaneous frame rate for each frame of the set of frames based on the elapsed time. In some examples, the frame rate manager 510 may determine a range of frame rates from a set of two or more ranges of frame rates, the range of frame rates including the average frame rate.

The refresh rate manager 515 may select a new refresh rate based on the average frame rate for the set of frames. In some examples, the refresh rate manager 515 may switch, based on selecting the new refresh rate, from a current refresh rate of the display to the new refresh rate by deactivating a first timing register of the device and activating a second timing register of the device.

In some cases, the new refresh rate is selected from a set of available refresh rates that includes the current refresh rate and the new refresh rate. In some cases, the first timing register is associated with the current refresh rate, and where the second timing register is associated with the new refresh rate.

In some cases, the second timing register includes one or more preconfigured refresh rate settings for the new refresh rate, and where activating the second timing register includes implementing at least one of the one or more preconfigured refresh rate settings.

In some cases, the one or more preconfigured refresh rate settings include one or more horizontal timing settings, or one or more vertical timing settings, or both. In some cases, the second timing register is activated on a next vertical blank interval.

The lookup table manager 520 may determine the average frame rate based on using the instantaneous frame rate of at least one frame from the set of frames as an input of a lookup table.

The mapping manager 525 may determine a mapping between the determined range of frame rates and the new refresh rate based on determining the average frame rate.

FIG. 6 shows a diagram of a system 600 including a device 605 that supports dynamic refresh rate adjustment improvement in accordance with aspects of the present disclosure. The device 605 may be an example of or include the components of device 305, device 405, or a device as described herein. The device 605 may include components for bi-directional voice and data communications including components for transmitting and receiving communications, including a display manager 610, an I/O controller 615, a transceiver 620, an antenna 625, memory 630, a processor 640, and a coding manager 650. These components may be in electronic communication via one or more buses (e.g., bus 645).

The display manager 610 may determine a set of frames for display on the device, determine an average frame rate for the set of frames over a duration based on a respective frame rate associated with each frame of the set of frames, select a new refresh rate based on the average frame rate for the set of frames, and switch, based on selecting the new refresh rate, from a current refresh rate of the display to the new refresh rate by deactivating a first timing register of the device and activating a second timing register of the device.

The I/O controller 615 may manage input and output signals for the device 605. The I/O controller 615 may also manage peripherals not integrated into the device 605. In some cases, the I/O controller 615 may represent a physical connection or port to an external peripheral. In some cases, the I/O controller 615 may utilize an operating system such as iOS®, ANDROID®, MS-DOS®, MS-WINDOWS®, OS/2®, UNIX®, LINUX®, or another known operating system. In other cases, the I/O controller 615 may represent or interact with a modem, a keyboard, a mouse, a touchscreen, or a similar device. In some cases, the I/O controller 615 may be implemented as part of a processor. In some cases, a user may interact with the device 605 via the I/O controller 615 or via hardware components controlled by the I/O controller 615.

The transceiver 620 may communicate bi-directionally, via one or more antennas, wired, or wireless links as described above. For example, the transceiver 620 may represent a wireless transceiver and may communicate bi-directionally with another wireless transceiver. The transceiver 620 may also include a modem to modulate the packets and provide the modulated packets to the antennas for transmission, and to demodulate packets received from the antennas.

In some cases, the wireless device may include a single antenna 625. However, in some cases the device may have more than one antenna 625, which may be capable of concurrently transmitting or receiving multiple wireless transmissions.

The memory 630 may include RAM and ROM. The memory 630 may store computer-readable, computer-executable code 635 including instructions that, when executed, cause the processor to perform various functions described herein. In some cases, the memory 630 may contain, among other things, a BIOS which may control basic hardware or software operation such as the interaction with peripheral components or devices.

The processor 640 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 640 may be configured to operate a memory array using a memory controller. In other cases, a memory controller may be integrated into the processor 640. The processor 640 may be configured to execute computer-readable instructions stored in a memory (e.g., the memory 630) to cause the device 605 to perform various functions (e.g., functions or tasks supporting dynamic refresh rate).

The code 635 may include instructions to implement aspects of the present disclosure, including instructions to support dynamic adjustment of a refresh rate of a display. The code 635 may be stored in a non-transitory computer-readable medium such as system memory or other type of memory. In some cases, the code 635 may not be directly executable by the processor 640 but may cause a computer (e.g., when compiled and executed) to perform functions described herein.

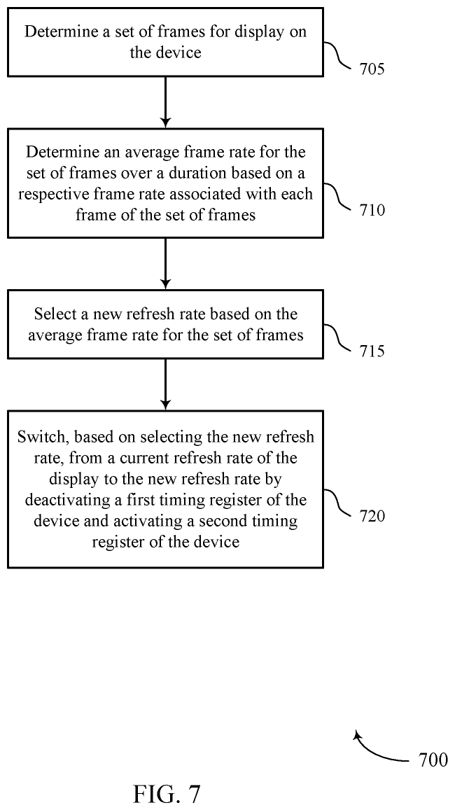

FIG. 7 shows a flowchart illustrating a method 700 that supports dynamic refresh rate adjustment improvement in accordance with aspects of the present disclosure. The operations of method 700 may be implemented by a device or its components as described herein. For example, the operations of method 700 may be performed by a display manager as described with reference to FIGS. 3 through 6. In some examples, a device may execute a set of instructions to control the functional elements of the device to perform the functions described below. Additionally or alternatively, a device may perform aspects of the functions described below using special-purpose hardware.

At 705, the device may determine a set of frames for display on the device. The operations of 705 may be performed according to the methods described herein. In some examples, aspects of the operations of 705 may be performed by a frame rate manager as described with reference to FIGS. 3 through 6.

At 710, the device may determine an average frame rate for the set of frames over a duration based on a respective frame rate associated with each frame of the set of frames. The operations of 710 may be performed according to the methods described herein. In some examples, aspects of the operations of 710 may be performed by a frame rate manager as described with reference to FIGS. 3 through 6.

At 715, the device may select a new refresh rate based on the average frame rate for the set of frames. The operations of 715 may be performed according to the methods described herein. In some examples, aspects of the operations of 715 may be performed by a refresh rate manager as described with reference to FIGS. 3 through 6.

At 720, the device may switch, based on selecting the new refresh rate, from a current refresh rate of the display to the new refresh rate by deactivating a first timing register of the device and activating a second timing register of the device. The operations of 720 may be performed according to the methods described herein. In some examples, aspects of the operations of 720 may be performed by a refresh rate manager as described with reference to FIGS. 3 through 6.

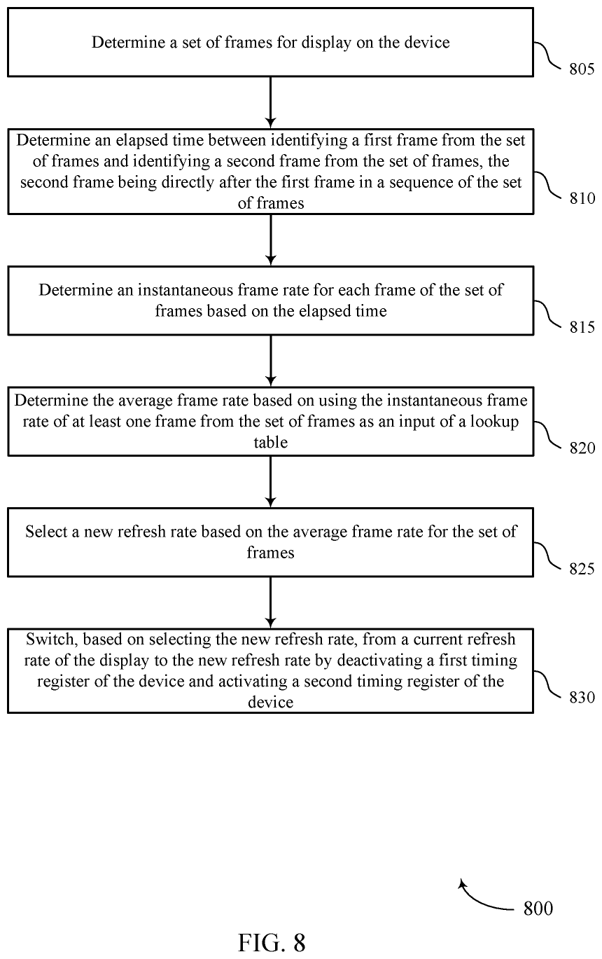

FIG. 8 shows a flowchart illustrating a method 800 that supports dynamic refresh rate adjustment improvement in accordance with aspects of the present disclosure. The operations of method 800 may be implemented by a device or its components as described herein. For example, the operations of method 800 may be performed by a display manager as described with reference to FIGS. 3 through 6. In some examples, a device may execute a set of instructions to control the functional elements of the device to perform the functions described below. Additionally or alternatively, a device may perform aspects of the functions described below using special-purpose hardware.

At 805, the device may determine a set of frames for display on the device. The operations of 805 may be performed according to the methods described herein. In some examples, aspects of the operations of 805 may be performed by a frame rate manager as described with reference to FIGS. 3 through 6.

At 810, the device may determine an elapsed time between identifying a first frame from the set of frames and identifying a second frame from the set of frames, the second frame being directly after the first frame in a sequence of the set of frames. The operations of 810 may be performed according to the methods described herein. In some examples, aspects of the operations of 810 may be performed by a frame rate manager as described with reference to FIGS. 3 through 6.

At 815, the device may determine an instantaneous frame rate for each frame of the set of frames based on the elapsed time. The operations of 815 may be performed according to the methods described herein. In some examples, aspects of the operations of 815 may be performed by a frame rate manager as described with reference to FIGS. 3 through 6.

At 820, the device may determine the average frame rate based on using the instantaneous frame rate of at least one frame from the set of frames as an input of a lookup table. The operations of 820 may be performed according to the methods described herein. In some examples, aspects of the operations of 820 may be performed by a lookup table manager as described with reference to FIGS. 3 through 6.

At 825, the device may select a new refresh rate based on the average frame rate for the set of frames. The operations of 825 may be performed according to the methods described herein. In some examples, aspects of the operations of 825 may be performed by a refresh rate manager as described with reference to FIGS. 3 through 6.

At 830, the device may switch, based on selecting the new refresh rate, from a current refresh rate of the display to the new refresh rate by deactivating a first timing register of the device and activating a second timing register of the device. The operations of 830 may be performed according to the methods described herein. In some examples, aspects of the operations of 830 may be performed by a refresh rate manager as described with reference to FIGS. 3 through 6.

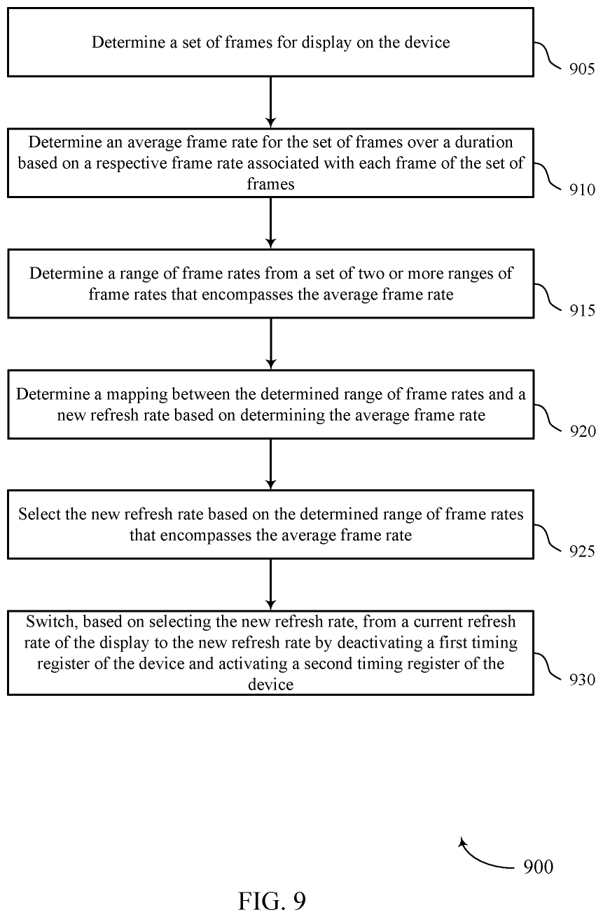

FIG. 9 shows a flowchart illustrating a method 900 that supports dynamic refresh rate adjustment improvement in accordance with aspects of the present disclosure. The operations of method 900 may be implemented by a device or its components as described herein. For example, the operations of method 900 may be performed by a display manager as described with reference to FIGS. 3 through 6. In some examples, a device may execute a set of instructions to control the functional elements of the device to perform the functions described below. Additionally or alternatively, a device may perform aspects of the functions described below using special-purpose hardware.

At 905, the device may determine a set of frames for display on the device. The operations of 905 may be performed according to the methods described herein. In some examples, aspects of the operations of 905 may be performed by a frame rate manager as described with reference to FIGS. 3 through 6.

At 910, the device may determine an average frame rate for the set of frames over a duration based on a respective frame rate associated with each frame of the set of frames. The operations of 910 may be performed according to the methods described herein. In some examples, aspects of the operations of 910 may be performed by a frame rate manager as described with reference to FIGS. 3 through 6.

At 915, the device may determine a range of frame rates from a set of two or more ranges of frame rates that encompasses the average frame rate. The operations of 915 may be performed according to the methods described herein. In some examples, aspects of the operations of 915 may be performed by a frame rate manager as described with reference to FIGS. 3 through 6.

At 920, the device may determine a mapping between the determined range of frame rates and a new refresh rate based on determining the average frame rate. The operations of 920 may be performed according to the methods described herein. In some examples, aspects of the operations of 920 may be performed by a mapping manager as described with reference to FIGS. 3 through 6.

At 925, the device may select the new refresh rate based on the determined range of frame rates that encompasses the average frame rate. The operations of 925 may be performed according to the methods described herein. In some examples, aspects of the operations of 925 may be performed by a refresh rate manager as described with reference to FIGS. 3 through 6.

At 930, the device may switch, based on selecting the new refresh rate, from a current refresh rate of the display to the new refresh rate by deactivating a first timing register of the device and activating a second timing register of the device. The operations of 930 may be performed according to the methods described herein. In some examples, aspects of the operations of 930 may be performed by a refresh rate manager as described with reference to FIGS. 3 through 6.

It should be noted that the methods described herein describe possible implementations, and that the operations and the steps may be rearranged or otherwise modified and that other implementations are possible. Further, aspects from two or more of the methods may be combined.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for dynamic refresh rate adjustment by a device, comprising:
determining a set of frames for display on the device;
determining an average frame rate for the set of frames over a duration based at least in part on a respective frame rate associated with each frame of the set of frames;
selecting a new refresh rate based at least in part on the average frame rate for the set of frames; and
switching, based at least in part on selecting the new refresh rate, from a current refresh rate of the display to the new refresh rate by deactivating a first timing register of the device and activating a second timing register of the device.

2. The method of claim 1, wherein determining the respective frame rate for each frame of the set of frames comprises:
determining an elapsed time between identifying a first frame from the set of frames and identifying a second frame from the set of frames, the second frame being directly after the first frame in a sequence of the set of frames.

3. The method of claim 2, wherein determining the respective frame rate for each frame of the set of frames further comprises:
determining an instantaneous frame rate for each frame of the set of frames based at least in part on the elapsed time.

4. The method of claim 3, wherein determining an average frame rate for the set of frames comprises:
determining the average frame rate based at least in part on using the instantaneous frame rate of at least one frame from the set of frames as an input of a lookup table.

5. The method of claim 1, wherein selecting the new refresh rate comprises:
determining a range of frame rates from a set of two or more ranges of frame rates, the range of frame rates including the average frame rate; and
determining a mapping between the determined range of frame rates and the new refresh rate based at least in part on determining the average frame rate.

6. The method of claim 1, wherein the new refresh rate is selected from a set of available refresh rates that comprises the current refresh rate and the new refresh rate.

7. The method of claim 1, wherein the first timing register is associated with the current refresh rate, and wherein the second timing register is associated with the new refresh rate.

8. The method of claim 1, wherein the second timing register includes one or more preconfigured refresh rate settings for the new refresh rate, and wherein activating the second timing register comprises implementing at least one of the one or more preconfigured refresh rate settings.

9. The method of claim 8, wherein the one or more preconfigured refresh rate settings comprise one or more horizontal timing settings, or one or more vertical timing settings, or both.

10. The method of claim 1, wherein the second timing register is activated on a next vertical blank interval.

11. An apparatus for dynamic refresh rate adjustment by a device, comprising:
a processor,
memory coupled with the processor; and
instructions stored in the memory and executable by the processor to cause the apparatus to:
determine a set of frames for display on the device;
determine an average frame rate for the set of frames over a duration based at least in part on a respective frame rate associated with each frame of the set of frames;
select a new refresh rate based at least in part on the average frame rate for the set of frames; and
switch, based at least in part on selecting the new refresh rate, from a current refresh rate of the display to the new refresh rate by deactivating a first timing register of the device and activating a second timing register of the device.

12. The apparatus of claim 11, wherein the instructions to determine the respective frame rate for each frame of the set of frames are executable by the processor to cause the apparatus to:
determine an elapsed time between identifying a first frame from the set of frames and identifying a second frame from the set of frames, the second frame being directly after the first frame in a sequence of the set of frames.

13. The apparatus of claim 12, wherein the instructions to determine the respective frame rate for each frame of the set of frames further are executable by the processor to cause the apparatus to:
determine an instantaneous frame rate for each frame of the set of frames based at least in part on the elapsed time.

14. The apparatus of claim 13, wherein the instructions to determine an average frame rate for the set of frames are executable by the processor to cause the apparatus to:
determine the average frame rate based at least in part on using the instantaneous frame rate of at least one frame from the set of frames as an input of a lookup table.

15. The apparatus of claim 11, wherein the instructions to select the new refresh rate are executable by the processor to cause the apparatus to:
determine a range of frame rates from a set of two or more ranges of frame rates, the range of frame rates including the average frame rate; and
determine a mapping between the determined range of frame rates and the new refresh rate based at least in part on determining the average frame rate.

16. The apparatus of claim 11, wherein the new refresh rate is selected from a set of available refresh rates that comprises the current refresh rate and the new refresh rate.

17. The apparatus of claim 11, wherein the first timing register is associated with the current refresh rate, and wherein the second timing register is associated with the new refresh rate.

18. The apparatus of claim 11, wherein the second timing register includes one or more preconfigured refresh rate settings for the new refresh rate, and wherein activating the second timing register comprises implementing at least one of the one or more preconfigured refresh rate settings.

19. A non-transitory computer-readable medium storing code for dynamic refresh rate adjustment by a device, the code comprising instructions executable by a processor to:
determine a set of frames for display on the device;
determine an average frame rate for the set of frames over a duration based at least in part on a respective frame rate associated with each frame of the set of frames;
select a new refresh rate based at least in part on the average frame rate for the set of frames; and
switch, based at least in part on selecting the new refresh rate, from a current refresh rate of the display to the new refresh rate by deactivating a first timing register of the device and activating a second timing register of the device.

20. The non-transitory computer-readable medium of claim 19, wherein the instructions to determine the respective frame rate for each frame of the set of frames are executable to:
determine an elapsed time between identifying a first frame from the set of frames and identifying a second frame from the set of frames, the second frame being directly after the first frame in a sequence of the set of frames.
